(19) United States
(12) Patent Application Publication
(10) Pub. No.: US 2006/0138116 A1
(43) Pub. Date: Jun. 29, 2006

(54) Thread control for welding wire

(75) Inventor: Geoffrey Michael Lipnevicius, Sagamore Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Lincoln Global, Inc.

(21) Appl. No.: 11/022,727

(22) Filed: Dec. 27, 2004

(51) Int. Cl. B23K 9/12

(52) U.S. Cl. 219/137.71

(57) ABSTRACT

A wire feeding control mechanism and method to obtain a certain stick-out of welding wire from a tip of a welding gun.

The present invention relates to the art of welding, and more particularly to a method and an apparatus for controlling the feeding of welding wire from a welding wire supply through a welding gun of a welding system.

### BACKGROUND OF THE INVENTION

Automated welding applications continue to increase in popularity. These automated welding operations are commonly used for high output, repetitive welding applications that commonly occur in various types of industrial applications (e.g., automotive industry, etc.). Welding systems such as automatic or robotic welders are commonly used in machine shops, automobile manufacturing facilities and other industrial facilities. The repetitive nature of the welding operation lends itself to a programmed operation of the welder to achieve a consistent and high quality weld bead for each repetitive welding operation.

In order to achieve the desired consistency in quality and appearance of the weld bead for each repetitive welding operation, the welding parameters during the operation of the welding procedure need to be consistent. In automated or robotic welding operations, many of the welding parameters (e.g., wire feed speed, current level, current waveform, shielding gas flow rate, movement pattern of robotic arc, etc.) are controlled to ensure that such welding parameters are duplicated for each repetitive welding operation. Although the control of these welding parameters greatly facilitates in the consistent formation of a high quality weld bead after the beginning of the welding process, quality control during the initial formation of the weld bead is more difficult to achieve.

One of the contributing factors associated with the inconsistent quality of the weld bead at the start of a welding operation is the stick-out distance of the electrode at the beginning of the welding operation. If the stick-out distance is too great or too small, a low quality weld bead will initially be formed. The problem associated with proper electrode stick-out occurs principally in two situations, namely 1) when a supply of welding wire is depleted and a new wire supply is fed into the welding gun, and 2) at the beginning of each repetitive welding operation. In both of these situations, an operator typically sets the correct stick-out distance for the electrode, and then allows the automated or robotic welding operation to proceed until the supply of welding wire is terminated. As for the second situation, the operator only adjusts the proper stick-out of the welding electrode at the beginning of the first repetitive welding operation. This manual process of setting the stick-out distance is a time-consuming operation and also resulted in some operator error when the proper distance was not selected. Furthermore, the end portion of some of the welding electrode was typically cutoff to obtain the desired stick-out distance, thus resulting is waste of the welding wire. Furthermore, because the stick-out of only the first repetitive welding operation was adjusted, subsequent repetitive welding operations may not have had the desired stick-out prior to the beginning of the formation of a weld bead, thus compromising the quality of the formed weld bead.

In the situation wherein the welding wire supply is depleted, an operator of the welding system was required to remove any remaining welding wire in or extending from the welding gun and cable to the welding gun. Thereafter, the operator replaced the empty welding wire spool with a new spool of welding wire. The loose end of the new spool of welding wire was then threaded through the wire feeder and welding gun until the welding wire exited the welding gun tip. The excess welding wire extending past the welding gun tip as a result of over-threading was manually trimmed or trimmed by an automatic cutter.

Several prior art systems have been developed to reduce the down-time associated with manually feeding welding wire from a new supply to the welding gun by implementing an apparatus that automatically connects the welding system to a fresh wire supply source upon depletion of welding wire on the current supply. However, these systems for automatically connecting to a fresh wire supply as well as the aforementioned manual feed systems require the welder or operator of the welding system to first remove any remaining welding wire in the welding gun and cable to the welding gun, and to also control the initial feeding of wire from the wire supply to the tip of the welding gun. This manual control of the initial feeding of wire from the supply to the tip of the welding gun typically required the welder to control an “inch forward” or “jog” button on the welding system until the welding wire was fed from the wire supply to the tip of the gun. This welding wire feeding process often resulted in the operator overextending the welding wire past the tip of the welding gun. This “overextending” or “over-shooting” then required the operator to either retract or trim the welding wire, both of which were time consuming operations.

One prior art threading process disclosed is U.S. Pat. No. 6,720,529, which is incorporated herein by reference, attempted to address the problem of the“down time” for re-supplying welding wire from a welding wire source to the robotic arm of the automated welding system. The '529 patent discloses a welding system wherein a precise amount of welding wire is fed to the welding gun of a welding system such that the welding wire need not be trimmed, thus reducing wire waste and operational delays. The '529 patent disclosed a welder control that, upon detection of an autothread input, determined the amount of time in which a motor of a wire feed drive assembly should be activated so as to supply an initial segment of welding wire to a welding gun of a welding system. The welder control was configured to activate a motor for driving welding wire from a wire source at a prescribed wire feed speed, and for determining the time until a desired amount of welding wire had been fed into the welding gun.

Although the '529 patent discloses a welding system that can reduce the amount of time to rethread the welding wire in a welding gun, the welding system does not include any arrangement to determine whether the proper amount of welding wire has indeed been threaded through the welding gun. The '529 patent only measures the amount of welding wire that should be payed out from the wire reel. However, if any welding wire slippage occurs from the wire feeder during the automated payout process, the desired stick-out of the welding wire will not be achieved. Furthermore, the '529 patent only addresses the problem associated with threading wire from a new reel of wire into the welding gun. The problem associated with proper wire stick-out prior to the beginning of each repetitive welding process is not addressed by the control mechanism disclosed in the '529 patent.

In view of the current state of the art of welding, there remains a need for a welding apparatus and method for ensuring that proper welding electrode stick-out is achieved prior to a particular welding procedure.

### SUMMARY OF THE INVENTION

The present invention is directed to a welding wire feeding system designed to ensure that the proper stick-out of the welding wire is obtained prior to the beginning of a particular welding process. The present invention also can be used to facilitate in the threading of a new source of welding wire into the welding gun of a welding apparatus. The invention is particularly directed to automatic or robotic welders; however, the invention can be used for semi-automatic welding operations and manual welding operations.

In one aspect of the present invention, there is provided a detection mechanism that detects the amount of welding wire extending from the tip of a welding gun. The amount of welding wire protruding from the tip of the welding gun is referred to as “stick-out” The present invention includes at least one mechanism that positively verifies the end position of the welding wire that is protruding from the tip of the welding gun. As such, the present invention is an advancement over the arrangement disclosed in Davidson U.S. Pat. No. 6,720,529 wherein the position of the welding wire is a calculated position based on the amount of welding wire that has supposedly been feed to the welding gun by a wire feeder. The present invention utilizes one or more mechanisms to detect the amount of welding wire extending from the tip of a welding gun. Non-limiting mechanisms that fall within the scope of the invention include, but are not limited to, non-physical contact verification of stick-out and/or physical contact verification of stick-out. Non-limiting examples of non-physical contact verification mechanisms include, but are not limited to, the use of one or more types of electromagnetic waves (e.g., video monitoring, lasers, sound waves, ultrasonic waves, infrared light, ultraviolet light, etc.), electric properties (e.g., current detection, voltage detection, resistance detection, etc.), and/or magnetic properties. One specific non-limiting mechanism that can be used for non-physical contact verification of stick-out includes the positioning of the welding gun in a set position and then advancing the welding wire until the end of the welding wire contacts or intersects at least a portion of a laser beam that is set at some defined distance from the tip of the welding gun, and that such contact or intersection with the laser beam verifies the position of the end of the welding wire relative to the tip of the welding gun. As can be appreciated, other or additional non-physical contact verification mechanisms for stick-out detection from the tip of the welding gun can be used. Non-limiting examples of physical contact verification mechanisms include physical contact with the end of welding wire, formation of an electric circuit from the contact of the welding wire with another electrically conducting device, etc. As can be appreciated, other or additional mechanisms can be used. One specific non-limiting mechanism that can be used for physical contact verification of stick-out from the tip of the welding gun includes the positioning of the welding gun in a set position and then advancing the welding wire until the end of the welding wire contacts or intersects a contact plate that is set at some defined distance from the tip of the welding gun. The contact of the end of the welding wire with the contact plate results in the prevention of further advancement of the welding wire and/or enables the conduction of a current from the welding wire through the contact plate. When current is conducted through the contact plate, the current level is typically a low level so that arcing and/or melting of the end of the welding electrode does not occur; however, this is not required. When the welding wire drive system detects resistance from further advancement of the welding wire and/or when electric contact is detected, the position of the end of the welding wire relative to the tip of the welding gun is verified. As can be appreciated, many other or additional physical contact verification mechanisms for stick-out detection can be used.

In another and/or alternative aspect of the present invention, the welding wire positioning mechanism can be used on an automatic or robotic welder and/or semi-automatic welding system. Robotic welders and semi-automated welders are commonly used to perform repetitive welding functions. The robotic welder and semi-automated welder guides a welding gun to perform a series of repetitive movements to ensure the formation of a consistent and high quality weld bead. The present invention can be incorporated into a robotic welder or semi-automated welder by requiring the arm that is holding the welding gun to move to a particular location prior to, during and/or after the beginning of the formation of a weld bead on a workpiece. Once the arm is moved to this particular location, the welding wire is advanced until the distance of the end of the welding wire from the tip of the welding gun (stick-out) is positively verified. Once positive verification is made, the welding process begins and/or continues. The use of this positive verification system can be selective (e.g., used after the formation of a plurality of weld beads), or non-selective (e.g., used prior to the formation of every weld bead, used multiple times during the formation of each weld bead, etc.). The verification system of the present invention not only can be used to positively verify the proper stick-out of the welding wire prior, during and/or after the formation of a weld bead, but the verification system can be also or alternatively used to facilitate in the feeding of a new source of welding wire into the welding gun, perform one or more diagnostic and/or calibration functions, facilitate in inventory control of the welding wire, facilitate in the quality control of the formed weld bead and/or other or additional uses. For example, the verification system can be used to facilitate in the feeding of a new source of welding wire into the welding gun. When the source of welding wire to the welding gun is changed, a new reel or container of welding wire is fed into a wire feeder, which then feeds the welding wire to the welding gun. The verification system of the present invention can be used to automatically verify that the new source of welding wire is fully threaded through the welding gun. For instance, the verification system can be used to monitor the end of the welding wire from the tip of the welding gun and signal the wire feeder to stop feeding the welding wire once the end of the welding wire from the new source of welding wire has protruded a desired length from the tip of the welding gun. Typically the wire feeder terminates the feeding of the welding wire by stopping the wire feed motor; however, other or additional mechanisms can be used.

As can be appreciated, many other or additional control arrangements can be used to facilitate in the feeding of a new source of welding wire into the welding gun. In another example, the verification system can be used to perform one or more diagnostic and/or calibration functions. For instance, when the wire feeder advances a particular amount of welding wire, the verification system of the present invention can be used to verify that such an amount of welding wire has indeed been advanced. If a discrepancy exists, the wire feeder can be calibrated, adjusted, and/or repaired to correct this discrepancy. As can be appreciated, many other or additional diagnostic and/or calibration functions can be used to facilitate in the feeding of the welding wire to the welding gun.

In another example, the verification system can be used to facilitate in inventory control and/or monitoring of the welding wire. For instance, when the wire feeder advances a particular amount of welding wire, the total amount of welding wire advanced by the wire feeder can be monitored to indicate the status or inventory of the welding wire remaining on the reel or in the wire container. The verification system of the present invention can be used to verify that such an amount of wire has indeed been advanced, and if a discrepancy exists, the inventory amount can be adjusted to obtain a more accurate tracking of the amount of welding wire used and/or remaining on a reel or in a wire container. As can be appreciated, many other or additional inventory functions can be facilitated by the use of the present invention. In another example, the verification system can be used to facilitate in the quality control of the weld bead. For instance, when the wire feeder advances the welding wire during a welding operation, the actual amount of welding wire advanced by the wire feeder can be monitored during and/or after the formation of the weld bead so as to confirm whether the proper amount of welding wire has been used in the formation of a particular weld bead. If an unacceptable amount of welding wire was used, the particular weld bead can be tagged for quality control purposes. As can be appreciated, many other or additional quality control functions can be facilitated by the use of the present invention.

In still another and/or alternative aspect of the present invention, the welding wire positioning mechanism can be used on non-automated or manual welding system. In non-automated welding operations, the operator typically advances the welding wire until the perceived proper wire stick-out from the tip of the welding gun is obtained. Thereafter, the operator begins a particular welding process. Due to the subjectiveness of individual operators, the perceived proper wire stick-out can vary from operator to operator and/or from weld bead to weld bead. The use of the present invention enables the operator to consistently achieve the proper welding wire stick-out for each welding operation. In one non-limiting example, the present invention can be incorporated on a non-automated welder by use of a welding gun harness or holder that is designed to support or hold a particular welding gun. After the operator places the welding gun in the holder or harness, the operator manually advances the welding wire, typically by depressing a trigger on the welding gun, until the one or more verification mechanisms of the present invention indicate that the proper stick-out of the welding wire has been achieved. Thereafter, the operator removes the welding gun from the harness or holder and begins a welding process. Whenever the desired stick-out verification is again required, the operator merely reinserts the welding gun in the harness or holder and then advances the wire until the one or more verification mechanisms of the present invention indicate that the proper stick-out of the welding wire has been achieved. The verification system of the present invention not only can be used to positively verify the proper stick-out of the welding wire prior, during, or after the formation of a weld bead, but the verification system can be also or alternatively be used to facilitate in the feeding of a new source of welding wire into the welding gun, perform one or more diagnostic and/or calibration functions, and/or to verify or monitor the inventory of the welding wire. For example, the verification system can be used to facilitate in the feeding of a new source of welding wire into the welding gun. When the source of welding wire to the welding gun is changed, a new reel or container of welding wire is fed into a wire feeder, which then feeds the welding wire to the welding gun. The verification system of the present invention can be used to verify that the new source of welding wire is fully threaded through the welding gun by monitoring the end of the welding wire from the tip of the welding gun and signal the wire feeder to stop feeding the welding wire once the end of the welding wire from the new source of welding wire has protruded a desired length from the tip of the welding gun. As can be appreciated, many other or additional control arrangements can be used to facilitate in the feeding of a new source of welding wire into the welding gun. In another example, the verification system can be used to perform one or more diagnostic and/or calibration functions. For instance, when the wire feeder advances a particular amount of welding wire, the verification system of the present invention can be used to verify that such an amount of wire has indeed been advanced. If a discrepancy exists, the wire feeder can be calibrated, adjusted and/or repaired to correct this discrepancy. As can be appreciated, many other or additional diagnostic and/or calibration functions can be used to facilitate in the feeding of the welding wire into the welding gun. In another example, the verification system can be used to facilitate in inventory control and/or monitoring of the welding wire. For instance, when the wire feeder advances a particular amount of welding wire, the total amount of welding wire advanced by the wire feeder can be monitored to indicate the status or inventory of the welding wire remaining on the reel or in the wire container. The verification system of the present invention can be used to verify that such an amount of wire has indeed been advanced, and if a discrepancy exists, the inventory amount can be adjusted to obtain a more accurate tracking of the amount of welding wire used and/or remaining on a reel or in a wire container. As can be appreciated, many other or additional inventory functions can be facilitated by the use of the present invention.

In yet another and/or alternative aspect of the present invention, the welding wire positioning mechanism can be connected to an automatic control system of an automatic, semi-automatic or robotic welding system. When the welding wire positioning mechanism is used with a robotic, automatic or semi-automatic welder, the welding wire positioning mechanism is typically connected to and/or integrated with the welding control system of the welder. For instance, the welding wire positioning mechanism can be connected to a controller and/or a peripheral controller that is designed to be used with a drive assembly of a welder. The interface with the welding wire positioning mechanism can include a processor configured to execute one or more instructions to monitor and/or control the welding wire position and/or feeding of the welding wire during a welding operation. Computer readable storage medium can be included with the welder system. This type of medium can include a computer program that controls and/or includes a set of instructions that can be executed by a computer to monitor and/or control the welding wire position and/or feeding of the welding wire during a welding operation. This computer readable storage medium can also be used to control other functions of the welding system (e.g., movement of the robotic arm, current waveform, current level, voltage level, shielding gas flow rate, etc.). The computer can be used to access a plurality of wire feeding parameters, determine welding wire inventory, determine and/or monitor various control and/or diagnostic parameters of the welder and/or wire feeder, control the wire feeder, control the waveform of the current from the welder, control the operating parameters of the welder, control the operation of the robotic welder arm, etc. In one non-limiting example, the control information for setting the distance the tip of the welding gun is maintained from a welding wire position verification mechanism can be made by manual input and/or from an electronic source (e.g., data chip, memory button, memory stick, data disk, internet, computer database, electronic circuit, etc.). As can be appreciated, other information for control or additional features of the welder can be from a manual and/or electronic source.

In summary, one non-limiting aspect of the present invention includes a wire feeding control mechanism used to obtain a certain stick-out of welding wire from a tip of a welding gun. The wire feed control mechanism includes a wire feeder that advances the welding wire, a positive verification mechanism that determines an actual amount of welding wire protruding from the tip of the welding gun, a controller to terminate advancement of the welding wire by the wire feeder after the positive verification mechanism detects that the welding wire has obtained a set stick-out from the tip of the welding gun. The welding gun can be connected to a robotic welder. The positive verification mechanism can include a non-physical contact verification arrangement and/or a physical contact verification arrangement. The physical contact verification arrangement can include a contact plate and a detector that detects physical contact of the welding wire with the contact plate and/or electrical contact of the welding wire with the contact plate. A robot arm controller can be provided that is designed to move a robot arm to a predefined position prior to the positive verification mechanism verifying the welding wire position. The robot arm is typically connected to the welding gun. When the wire feed control mechanism is used for a manual welder, a welding gun holder is typically provided. The welding gun holder can include a connector for releasably connecting the welding gun and a contact plate that is positioned a set distance from the connector. The distance of the contact plate from the connector can be fixed or adjustable. In another non-limiting aspect of the invention, there is provided an automatic or semi-automatic welding system that includes a robotic arm, a welding gun connected to the robotic arm, a robotic arm control to control movement of the robotic arm, a wire feeder designed to advance welding wire through the welding gun, and a wire feeding control mechanism to obtain a certain stick-out of welding wire from a tip of the welding gun and a welding controller of at least one parameter of a welder. The wire feeding control mechanism can include a positive verification mechanism that determines an actual amount of welding wire protruding from the tip of the welding gun and a controller to terminate advancement of the welding wire by the wire feeder after the positive verification mechanism detects that the welding wire has obtained a set stick-out from the tip of the welding gun. The positive verification mechanism can include a non-physical contact verification arrangement and/or a physical contact verification arrangement. The physical contact verification arrangement can include a contact plate and a detector that detects physical contact of the welding wire with the contact plate and/or electrical contact of the welding wire with the contact plate. A robot controller can be provided which can include a data input for setting a distance the robot arm maintains at the tip of the welding gun from the positive verification mechanism. The data input can be designed to receive data from a manual entry and/or an electronic source. The wire feeding control mechanism can be designed to advance the welding wire at a preset speed as the positive verification mechanism detects said welding wire. A wire feed monitor can be provided which can be designed to compare an actual amount of welding wire advanced by the wire feeder to a calculated amount of welding wire based on a feeding rate of the wire feeder. An autothread controller can be provided which can be designed to facilitate in threading a new source of welding wire into the welding gun. The autothread controller can be designed to generate a control signal to cause the wire feeder to advance the new source of welding wire through the welding gun. The autothread controller can also be designed to generate a termination signal to cause the wire feeder to terminate advancement of the new source of welding wire when the positive verification mechanism detects the welding wire has advanced to a preset distance from the tip of the welding gun. The welding controller can be designed to control at least one welding parameter such as, but not limited to, current waveform, voltage level, current level and/or shielding gas flow rate. The welding system can include a computer readable storage medium that includes a computer program and/or a set of instructions stored on the computer readable storage medium. The information on the computer readable storage medium, when read by the robotic arc controller, the wire feeding control and/or the welding controller, causes at least one of the controllers to control a feed rate of the welding wire, the position of the robotic arm and/or at least one welding parameter. In another non-limiting aspect of the present invention, there is provided a method of automatically controlling stick-out of a welding wire from a tip of a welding gun. The method includes providing a source of welding wire, providing a wire feeder to advance the welding wire, positively verifying the position of the welding wire that extends from said tip of the welding gun, and causing the wire feeder to advance the welding wire until the welding wire is positively verified at a certain position from the tip of the welding gun. The step of positively verifying can include the use of a non-physical contact verification arrangement and/or a physical contact verification arrangement. The method can include the step of entering data to set a distance the welding tip is maintained from a select position. Another non-limiting aspect of the present invention includes a method of automatically controlling stick-out of a welding wire from a tip of a welding gun that includes the steps of engaging an arc detection circuit, moving a welding gun to a preselected distance from a fixed detection point, and advancing the welding wire until the welding wire is detected at the fixed detection point.

One object of the present invention is the provision of a welding wire positioning mechanism that at least partially controls and/or monitors the stick-out of welding wire from a welding gun.

Another and/or additional object of the present invention is the provision of a welding wire positioning mechanism that positively verifies the stick-out of welding wire from the tip of a welding gun.

Still another and/or additional object of the present invention is the provision of a welding wire positioning mechanism that improves weld bead quality.

Yet another and/or additional object of the present invention is the provision of a welding wire positioning mechanism that can be used with automatic or semiautomatic welders.

Still yet another and/or additional object of the present invention is the provision of a welding wire positioning mechanism that decreases human error in the selection of proper welding wire stick-out from a welding gun.

A further and/or additional object of the present invention is the provision of a welding wire positioning mechanism that facilitates in diagnostic and/or calibration functions of a welder, facilitates in inventory control and/or monitoring of the welding wire, facilitates in the feeding of a new source of welding wire into the welding gun, and/or facilitates in the quality control of the formed weld bead.

These and other objects and advantages of the invention will become apparent to those skilled in the art upon reading and following this description taken together with the accompanying drawings.

### BRIEF DESCRIPTION OF THE DRAWINGS

Reference may now be made to the drawings which illustrate various embodiments that the invention may take in physical form and certain parts and arrangements of parts wherein:

FIG. 1 is a perspective view of an automatic or semi-automatic welder system that includes a welding wire positioning mechanism that at least partially controls and/or monitors the stick-out of welding wire from a welding gun in accordance with the present invention;

FIG. 2 is a perspective view of an automatic or semi-automatic welder of FIG. 1 illustrating the formation of a weld bead on a workpiece;

FIGS. 3 and 4 are enlarged sectional views of the wire positioning mechanism of FIG. 1;

FIG. 5 is a flow chart illustrating one method of operation of the wire positioning mechanism in accordance with the present invention; and,

FIGS. 6 and 7 are a perspective view of a manual welder system that includes a welding wire positioning mechanism that at least partially controls and/or monitors the stick-out of welding wire from a welding gun in accordance with the present invention.

### DESCRIPTION OF PREFERRED EMBODIMENTS

Referring now to the drawings, wherein the drawings are for the purpose of illustrating the preferred embodiments of the invention only and not for the purpose of limiting the same, FIGS. 1-4 illustrate a robotic welder system 10 that includes a robotic arm 20, a welding power source 30, a robot control 40, a welding wire reel 50 that includes a source of welding wire 52, and a wire feeder 60. The robotic welding system can include other components such as, but not limited to, shield gas source, an external monitoring and/or control interface, etc. The robotic welding system is particularly applicable for MIG welding, pulsed MIG welding, and MAG welding for high output and/or industrial welding environments such as those more commonly encountered in various types of manufacturing facilities; however, it will be appreciated, that the welding system can be used in other types of welding operations.

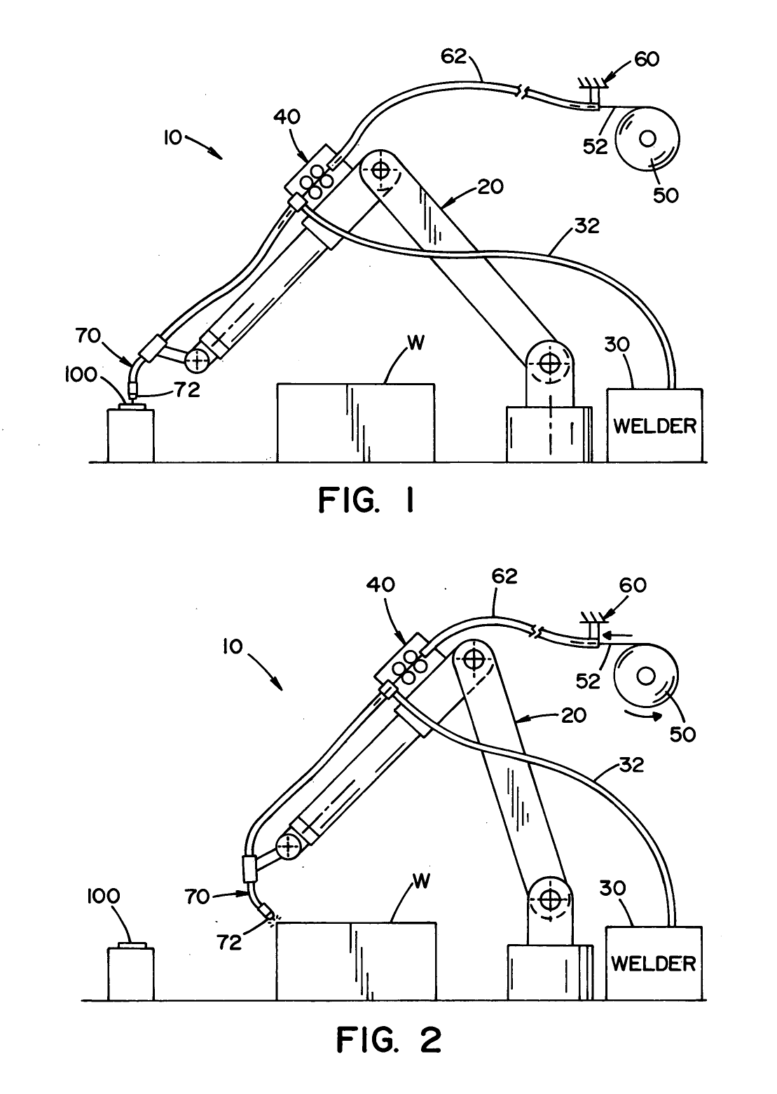

The robot control 40 is designed to control the movement of the welding arm to various positions so as to achieve the desired weld bead. Typically this information is pre-programmed into a robot control; however, this is not required. As illustrated in FIG. 2, robot control 40 has caused the robot arm to position the welding gun 70 above a contact plate 100. This distance can be selected manually or electronically provided (e.g., data set of information from a database, etc.). As illustrated in FIG. 2, robot control 40 has caused the robot arm to position the welding gun 70 on a workpiece W to begin the formation of a weld bead on the workpiece. The robot control is interfaced with welding power source 30 and wire feeder 60 so that the desired arc welding current and desired amount of welding wire is fed to the workpiece to form the desired weld bead on the workpiece. As shown in FIGS. 1 and 2, wire feeder 60 is connected to robot control 40 by a cable 62 and welding power source 30 is connected to robot control 40 by a cable 32. As can be appreciated, other or additional interface arrangements can be used (e.g., wireless transmissions, etc.). The interfacing of these components to form a weld bead is known in the art, thus will not be further described in detail. The welding program used to operate the welding system can be included in the welding power source, the wire feeder, the robot control, and/or be at least partially located at a remote location. Various types of welding parameters (e.g., wire feed speed, current waveform, voltage level, current level, shielding gas flow rate, robot arm position, etc.) can be set and/or programmed to operate the robot welder.

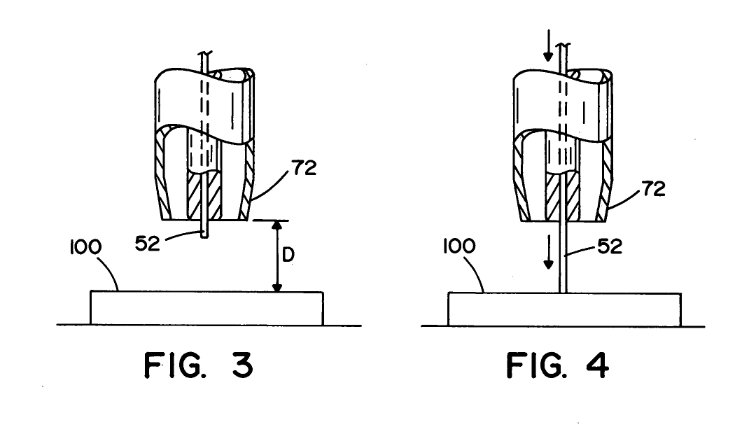

Referring again to FIG. 1, the robot control 40 has caused robot arm 20 to position the tip of the welding gun 70 at some defined distance above contact plate 100. As set forth above, the position of the robot arm can be programmed, or the position can be manually inputted. The relationship of the welding gun tip to the contact plate is better illustrated in FIGS. 3 and 4. As illustrated in FIG. 3, tip 72 of the welding gun is positioned a distance D above contact plate 100. Distance D represents the desired stick-out distance of the welding wire 52 from the tip 72 of the welding gun. The robotic controller can be preprogrammed to ensure that the robot arm is positioned so that tip 72 is at a defined distance D above the contact plate 100. This distance can be manually or automatically inputted. Once tip 72 is positioned the set distance above the contact plate, the wire feeder is activated to cause the welding wire to advance toward the contact plate. The welding wire is typically advanced by small increments until the end of the welding wire contacts the contact plate; however, the welding wire can be advanced in other ways. As shown in FIG. 4, the welding wire has been advanced to contact the contact plate. The detection of the contact of the welding wire with the contact plate can be by detection of the flow of a low level current between the welding wire and the contact plate. Upon detection of such current flow, a signal is sent to one or more controllers of the welding system to cause the wire feeder to terminate the advancement of the welding wire. Once the proper stick-out of the welding wire has been positively verified, the robot arm moves to workpiece W as illustrated in FIG. 2 and begins the formation of a weld bead on the workpiece. This control arrangement of the present invention enables the welding wire to be automatically positioned at the desired stick-out from the tip of the welding gun, thus the need of an operator having to hold or activate an “inch forward” or “jog forward” button to obtain a proper stick-out is eliminated.

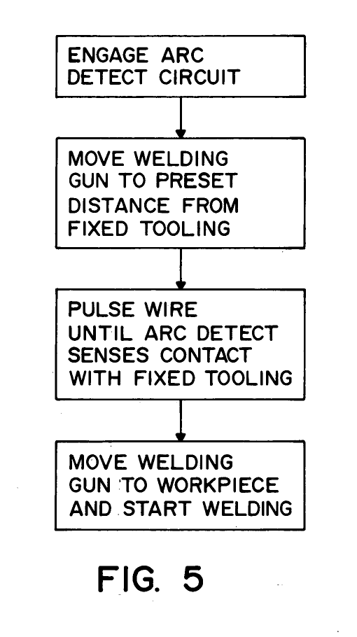

One non-limiting method of operation of the robotic welder system is illustrated in FIG. 5. The first step of the method involves the engagement of the arc detection circuit. This circuit or program can be preprogrammed or manually set by an operator, or can be a hard wired circuit. The program or circuit sets the position or distance D of the tip of the welding gun from the contact plate. Once the circuit or program has been activated, the second step results in the robot control moving the robot arm to a position such that the tip of the welding gun is positioned at the selected distance D from the contact plate as illustrated in FIG. 1. Once the robot arm has been moved, the third step involves the activation of the wire feeder to cause the wire weeder to inch or pulse forward from the tip of the welding gun until the end of the welding wire contacts the contact plate. Once the welding wire has contacted the contact plate, the desired stick-out of the welding wire has been achieved. Step four of the method results in the robot control moving the robot arm to a workpiece W to begin the formation of a weld bead on the workpiece as illustrated in FIG. 2.

The steps set forth in FIG. 5 can be performed after each weld bead has been formed on a particular workpiece or after a certain number of weld beads have been applied to a certain number of workpieces. As can also be appreciated, the steps set forth in FIG. 5 can also or alternatively be executed during the formation of a weld bead. As a result of this improved control system, the waste involved in cutting the welding wire to obtain the desired stick-out is eliminated, the time involved in obtaining the desired stick-out is reduced, and the quality of the formed weld beads can be improved.

As can be appreciated, the steps set forth in FIG. 5 can be used to properly feed a new wire source into the robot welding system, to perform diagnostic tests on one or more components of the robotic welding system, and/or to monitor the quality control of the formed weld beads. In prior welding wire threading processes, an operator depressed an “inch forward” or “jog forward” button to manually thread a new source of welding wire from the wire reel through the wire feeder and into the welding gun. Oftentimes, the welding wire would be threaded past the desired stick-out length, thereby requiring the operator to either retract the welding wire back through the welding gun, which can result in a “bird's nest”, or require trimming of the excess welding wire thereby resulting in waste. The system and method of the present invention can be used to overcome these problems of past robotic welding systems. The threading of the robotic welding system can be fully automated or semi-automated. For a fully automated system, an automatic mechanical arrangement is used to replace a used wire reel and insert a new wire reel on the robotic welder system. Thereafter, the end of the welding wire is automatically fed into the wire feeder. For a semi-automatic threading system, an operator takes the necessary steps of threading welding wire from a new wire supply into a wire feeder. Thereafter, the operator activates the robotic welding system to cause the performance of the steps set forth in FIG. 5.

As can be appreciated, when the new source of welding wire is being threaded into the robotic welding system, the actual amount of welding wire fed by the wire feeder to the calculated amount of fed welding wire can be monitored and compared to determined the precision at which the wire feeder is feeding the welding wire. If a discrepancy is determined, the wire feeder can be checked to determine if wire slippage is occurring and/or if one or more other measured parameters requires adjustment or calibration.

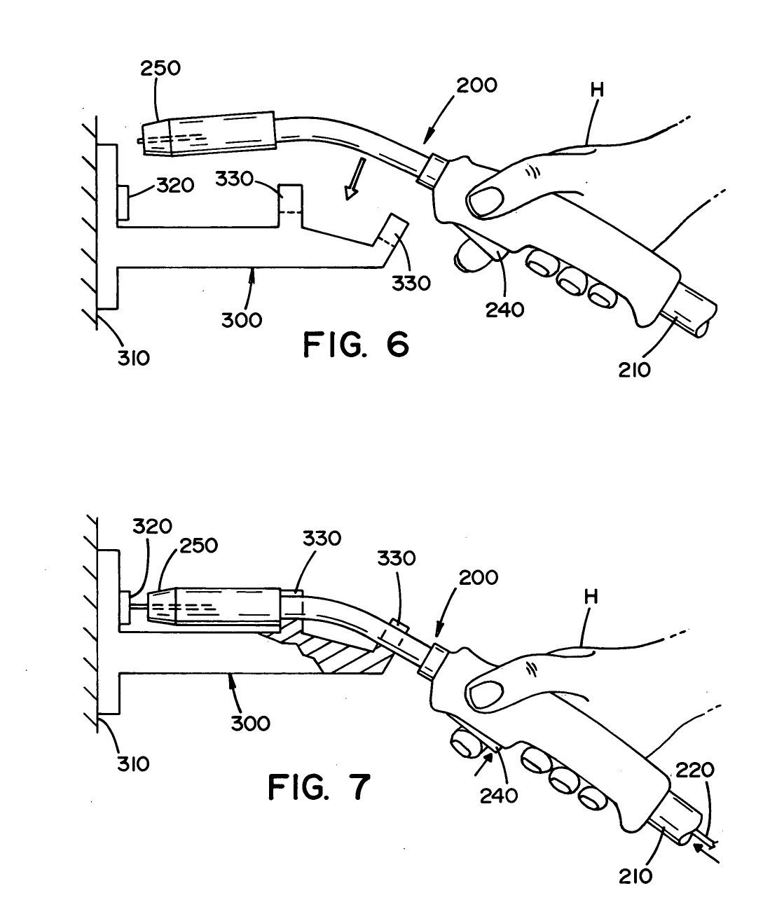

Referring now to FIGS. 6 and 7, there is illustrated a welding wire positioning mechanism that is used on a nonautomatic or manual welding system. As shown in FIG. 6, there is provided a welding gun 200 that is being held by the hand H of an operator. The welding gun is connected to a cable 210 that is connected to a welder, now shown. A welding wire 220 is fed through cable 210 and into the welding gun. The welding gun includes a trigger 240 that is used to advance the welding wire through the tip 250 of the welding gun. The operation of a welding gun and the use of a trigger to advance a welding wire is known in the art, thus details concerning such operation will not be repeated herein. The welding wire positioning mechanism of the present invention for a nonautomatic or manual welding system can include the use of a holder or harness 300. The holder or harness 300 can be mounted to a structure 310 such as, but not limited to, the housing of a welder or other type of device, or can be a handheld holder or harness. The holder or harness includes a contact plate 320 and a gun connector 330. In operation, the welding gun is inserted in the connector of the holder or harness. By properly positioning the welding gun in the connector, the tip 250 of the welding gun is spaced a certain distance from the contact plate 320. This distance represents the proper stick-out distance of the welding wire from the tip of the welding gun. The position of the connector and/or the contact plate can be fixed or adjustable. When the contact plate and/or connector is adjustable, the operator can adjust the distance of the contact plate from the tip of the welding gun to a desired distance. Once the welding gun is positioned in the connector of the holder or harness, the operator depresses the trigger 240 as illustrated in FIG. 7 to cause the welding wire to advance until the welding wire contacts the contact plate. Once the welding wire contacts the contact plate, the proper stick-out is obtained. The termination of the advancement of the welding wire can be manual by the operator releasing the trigger after the welding wire contacts the contact plate, and/or the termination can be automatic wherein the contact of the welding wire with the contact plate results in the wire feeder automatically terminating the advancement of the welding wire. The use of the holder or harness results in the simple and quick method of obtaining the proper stick-out of the welding wire.

The invention has been described with reference to a preferred embodiment and alternatives thereof. It is believed that many modifications and alterations to the embodiments disclosed readily suggest themselves to those skilled in the art upon reading and understanding the detailed description of the invention. It is intended to include all such modifications and alterations insofar as they come within the scope of the present invention.

1. A wire feeding control mechanism to obtain a stick-out of welding wire from a tip of a welding gun prior to the welding wire contacting a workpiece and prior to the beginning of a welding process on the workpiece comprising a wire feeder that advances the welding wire, a positive verification mechanism that determines an actual amount of welding wire protruding from said tip of said welding gun, a controller to terminate advancement of said welding wire by said wire feeder after said positive verification mechanism detects that said welding wire has obtained a set stick-out from said tip of said welding gun.

2. The mechanism as defined in claim 1, wherein said welding gun is connected to a robotic welder.

3. The mechanism as defined in claim 1, wherein said positive verification mechanism includes a non-physical contact verification arrangement, a physical contact verification arrangement or combinations thereof.

4. The mechanism as defined in claim 2, wherein said positive verification mechanism includes a non-physical contact verification arrangement, a physical contact verification arrangement or combinations thereof.

5. The mechanism as defined in claim 3, wherein said positive verification mechanism includes a physical contact verification arrangement, said physical contact verification arrangement includes a contact plate positioned remotely from the workpiece and a detector that detects physical contact of said welding wire with said contact plate, electrical contact of said welding wire with said contact plate, or combinations thereof.

6. The mechanism as defined in claim 4, wherein said positive verification mechanism includes a physical contact verification arrangement, said physical contact verification arrangement includes a contact plate positioned remotely from the workpiece and a detector that detects physical contact of said welding wire with said contact plate, electrical contact of said welding wire with said contact plate, or combinations thereof.

7. The mechanism as defined in claim 2, including a robot arm controller designed to move a robot arm to a predefined position prior to said positive verification mechanism verifying said welding wire position, said robot arm connected to said welding gun.

8. The mechanism as defined in claim 6, including a robot arm controller designed to move a robot arm to a predefined position relative to said contact plate prior to said positive verification mechanism verifying said welding wire position, said robot arm connected to said welding gun.

9. The mechanism as defined in claim 5, wherein said positive verification mechanism includes a welding gun holder, said welding gun holder including a connector for releasably connecting said welding gun and said contact plate that is positioned a set distance from said connector.

10. The mechanism as defined in claim 6, wherein said positive verification mechanism includes a welding gun holder, said welding gun holder including a connector for releasably connecting said welding gun and said contact plate that is positioned a set distance from said connector.

11. (canceled)

12. The mechanism as defined in claim 9, wherein said distance of said contact plate from said connector is adjustable.

13. The mechanism as defined in claim 10, wherein said distance of said contact plate from said connector is adjustable.

14. An automatic or semi-automatic welding system comprising a robotic arm, a welding gun connected to said robotic arm, a robotic arm control to control movement of said robotic arm, a wire feeder designed to advance welding wire through said welding gun, wire feeding control mechanism to obtain a certain stick-out of welding wire from a tip of said welding gun and a welding controller to control at least one parameter of a welder, said wire feeding control mechanism including a positive verification mechanism that determines an actual amount of welding wire protruding from said tip of said welding gun prior to the welding wire contacting a workpiece and prior to the beginning of a welding process on the workpiece and a controller to terminate advancement of said welding wire by said wire feeder after said positive verification mechanism detects that said welding wire has obtained a set stick-out from said tip of said welding gun.

15. The welding system as defined in claim 14, wherein said positive verification mechanism includes a non-physical contact verification arrangement, a physical contact verification arrangement or combinations thereof.

16. The welding system as defined in claim 15, wherein said positive verification mechanism includes a physical contact verification arrangement, said physical contact verification arrangement includes a contact plate and a detector that detects physical contact of said welding wire with said contact plate positioned remotely from the workpiece, electrical contact of said welding wire with said contact plate, or combinations thereof.

17. The welding system as defined in claim 14, wherein said robot controller includes a data input for setting a distance said robot arm maintains from said tip of said welding gun from said positive verification mechanism, said data input designed to receive data from a manual entry, an electronic source, or combinations thereof.

18. The welding system as defined in claim 15, wherein said robot controller includes a data input for setting a distance said robot arm maintains from said tip of said welding gun from said positive verification mechanism, said data input designed to receive data from a manual entry, an electronic source, or combinations thereof.

19. The welding system as defined in claim 16, wherein said robot controller includes a data input for setting a distance said robot arm maintains from said tip of said welding gun from said positive verification mechanism, said data input designed to receive data from a manual entry, an electronic source, or combinations thereof.

20. The welding system as defined in claim 14, wherein said wire feeding control mechanism advances said welding wire at a preset speed as said positive verification mechanism detects said welding wire.

21. The welding system as defined in claim 15, wherein said wire feeding control mechanism advances said welding wire at a preset speed as said positive verification mechanism detects said welding wire.

22. The welding system as defined in claim 19, wherein said wire feeding control mechanism advances said welding wire at a preset speed as said positive verification mechanism detects said welding wire.

23. The welding system as defined in claim 14, including a wire feed monitor to compare an actual amount of welding wire advanced by said wire feeder to a calculated amount of welding wire based on a feeding rate of said wire feeder.

24. The welding system as defined in claim 15, including a wire feed monitor to compare an actual amount of welding wire advanced by said wire feeder to a calculated amount of welding wire based on a feeding rate of said wire feeder.

25. The welding system as defined in claim 22, including a wire feed monitor to compare an actual amount of welding wire advanced by said wire feeder to a calculated amount of welding wire based on a feeding rate of said wire feeder.

26. The welding system as defined in claim 14, including an autothread controller to facilitate in threading a new source of welding wire into said welding gun, said autothread controller designed to generate a control signal to cause said wire feeder to advance said new source of welding wire through said welding gun, said autothread controller designed to generate a termination signal to cause said wire feeder to terminate advancement of said new source of welding wire when said positive verification mechanism detects said welding wire has advanced to a preset distance from said tip of said welding gun.

27. The welding system as defined in claim 15, including an autothread controller to facilitate in threading a new source of welding wire into said welding gun, said autothread controller designed to generate a control signal to cause said wire feeder to advance said new source of welding wire through said welding gun, said autothread controller designed to generate a termination signal to cause said wire feeder to terminate advancement of said new source of welding wire when said positive verification mechanism detects said welding wire has advanced to a preset distance from said tip of said welding gun.

28. The welding system as defined in claim 25, including an autothread controller to facilitate in threading a new source of welding wire into said welding gun, said autothread controller designed to generate a control signal to cause said wire feeder to advance said new source of welding wire through said welding gun, said autothread controller designed to generate a termination signal to cause said wire feeder to terminate advancement of said new source of welding wire when said positive verification mechanism detects said welding wire has advanced to a preset distance from said tip of said welding gun.

29. The welding system as defined in claim 14, wherein said welding controller controls at least one welding parameter selected from the group consisting of current waveform, voltage level, current level, shielding gas flow rate, or combinations thereof.

30. The welding system as defined in claim 15, wherein said welding controller controls at least one welding parameter selected from the group consisting of current waveform, voltage level, current level, shielding gas flow rate, or combinations thereof.

31. The welding system as defined in claim 28, wherein said welding controller controls at least one welding parameter selected from the group consisting of current waveform, voltage level, current level, shielding gas flow rate, or combinations thereof.

32. The welding system as defined in claim 14, including a computer readable storage medium that includes a computer program, a set of instructions, or combinations thereof, stored on said computer readable storage medium, said information on said computer readable storage medium when read by said robotic arc controller, said wire feeding control, said welding controller, or combinations thereof, causes at least one of said controllers to control a feed rate of said welding wire, the position of said robotic arm, at least one welding parameter, or combinations thereof.

33. The welding system as defined in claim 15, including a computer readable storage medium that includes a computer program, a set of instructions, or combinations thereof, stored on said computer readable storage medium, said information on said computer readable storage medium when read by said robotic arc controller, said wire feeding control, said welding controller, or combinations thereof, causes at least one of said controllers to control a feed rate of said welding wire, the position of said robotic arm, at least one welding parameter, or combinations thereof.

34. The welding system as defined in claim 31, including a computer readable storage medium that includes a computer program, a set of instructions, or combinations thereof, stored on said computer readable storage medium, said information on said computer readable storage medium when read by said robotic arc controller, said wire feeding control, said welding controller, or combinations thereof, causes at least one of said controllers to control a feed rate of said welding wire, the position of said robotic arm, at least one welding parameter, or combinations thereof.

35. A method of automatically controlling stick-out of a welding wire from a tip of a welding gun prior to the welding wire contacting a workpiece and prior to the beginning of a weld process comprising:
providing a source of welding wire;
providing a wire feeder to advance said welding wire;
positively verifying the position of said welding wire that extends from said tip of said welding gun, said positive verification occurring at a location remote to said workpiece;
causing said wire feeder to advance said welding wire until said welding wire is positively verified at a certain position from said tip of said welding gun; and,
moving said tip of said welding gun to a location of said workpiece to begin the welding of said workpiece.

36. The method as defined in claim 35, wherein said step of positively verifying includes a non-physical contact verification arrangement, a physical contact verification arrangement or combinations thereof.

37. The method as defined in claim 36, wherein said step of positively verifying includes a contact plate and a detector that detects physical contact of said welding wire with said contact plate positioned remotely from the workpiece, electrical contact of said welding wire with said contact plate, or combinations thereof.

38. The method as defined in claim 35, including the step of entering data to set a distance said welding tip is maintained from a select position.

39. The method as defined in claim 36, including the step of entering data to set a distance said welding tip is maintained from a select position.

40. The method as defined in claim 37, including the step of entering data to set a distance said welding tip is maintained from a select position.

41. (canceled)

42. The method as defined in claim 35, including the step of monitoring an actual amount of welding wire advanced by said wire feeder and comparing such monitored amount to a calculated amount of welding wire based on a feeding rate of said wire feeder.

43. The method as defined in claim 37, including the step of monitoring an actual amount of welding wire advanced by said wire feeder and comparing such monitored amount to a calculated amount of welding wire based on a feeding rate of said wire feeder.

44. The method as defined in claim 40, including the step of monitoring an actual amount of welding wire advanced by said wire feeder and comparing such monitored amount to a calculated amount of welding wire based on a feeding rate of said wire feeder.

45. The method as defined in claim 35, including the steps of automatically in threading a new source of welding wire into said welding gun and terminating advancement of said new source of welding wire when said welding wire has been positively verified to have advanced a preset distance from said tip of said welding gun.

46. The method as defined in claim 42, including the steps of automatically in threading a new source of welding wire into said welding gun and terminating advancement of said new source of welding wire when said welding wire has been positively verified to have advanced a preset distance from said tip of said welding gun.

47. The method as defined in claim 44, including the steps of automatically in threading a new source of welding wire into said welding gun and terminating advancement of said new source of welding wire when said welding wire has been positively verified to have advanced a preset distance from said tip of said welding gun.

48. A method of automatically controlling stick-out of a welding wire from a tip of a welding gun comprising:
engaging an arc detection circuit;
moving a welding gun to a preselected distance from a fixed detection point, said detection point positioned at a location remotely from a workpiece to later be welded by the welding gun; and,
advancing said welding wire until said welding wire is detected at said fixed detection point.
